(19) United States
(12) Patent Application Publication
(10) Pub. No.: US 2003/0048191 A1
(43) Pub. Date: Mar. 13, 2003

(54) Denton's sumpump alarm company

(76) Inventor: Juangi Michael Denton, Universty Park, IL (US)

Correspondence Address: Juangi Micheal Denton, 604 Farmview Court, University Park, IL, 60466, US

(21) Appl. No.: 09/970,742

(22) Filed: Oct. 3, 2001

Related U.S. Application Data
(60) Provisional application No. 60/285,062, filed on Apr. 20, 2001.

(51) Int. Cl. G08B 21/00

(52) U.S. Cl. 340/616; 340/620

(57) ABSTRACT

A sump pump alarm comprises a 120 db, 600 ma 12 vdc siren with a mounting bracket thats screwed into a floor joist over head. The siren also has a three pulse sound pattern to be heard, a 120 vac/12 vdc output adapter thats 100 ma of acceptance maximum for current load, thats contained inside of a 5×7×3 inch plastic black box. The adapter has a 9 ft. extention cord connecting from 120 vac wall outlet and the negative side of the 14 gauge extention to the 12 vdc adapter, and a 12 vdc flashing led thats connected by a 22 gauge wire coming out of the 12 vdc siren, and a 14 gauge solid wire thats put at least 12 inches below the normal water level in the well for grounding, this wire comes from either a water pipe ground or natural ground of the water to a metal discharge pipe in the well. And a 14 gauge solid wire that hangs up over the normal water level by one inch for detection of water rising, due to the sump pump failing. this wire along with two others are for water sensing, is coming directly from the negative side of the 12 vdc adapter. A momentary test button to test the alarm system, thats connected on one side of the switch to the negative side of the 12 vdc adapter and the other side of it is connected to the terminal of the lighted rocker switch thats connected to negative side of the 120 vac wall outlet, a 120 vac illuminated rocker switch thats connected by its first terminal directly to positive ac side of the 12 vdc adapter, the second terminal of the rocker switch is connected to the positive side of the wall outlet, and the third terminal of the rocker is connected to the negative side of the wall outlet and to the one side of the momentary test button.

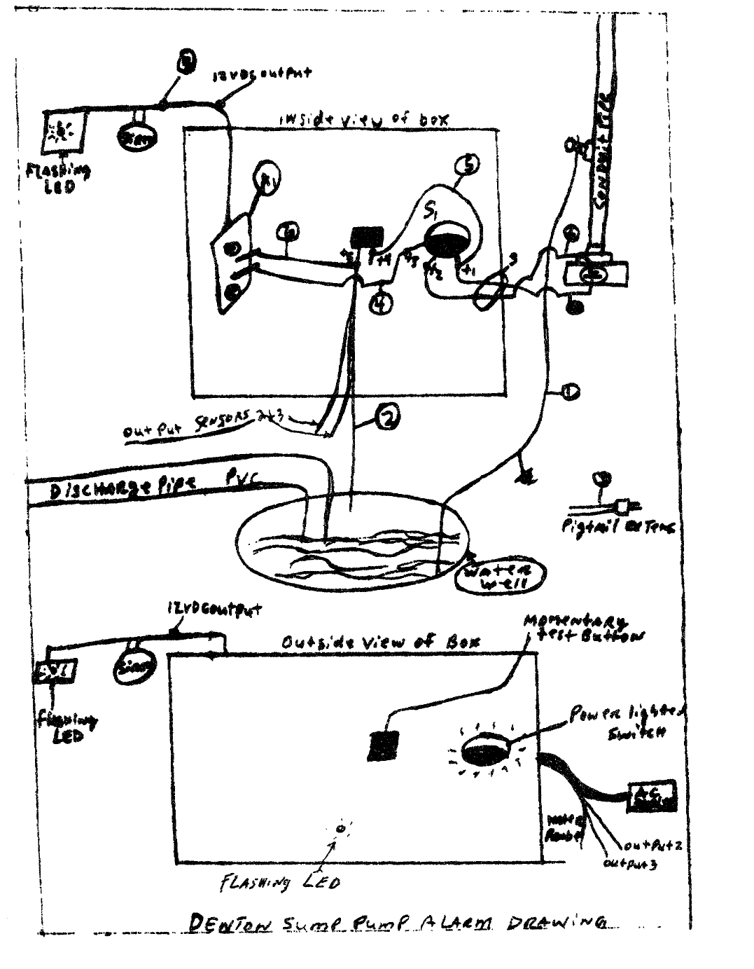

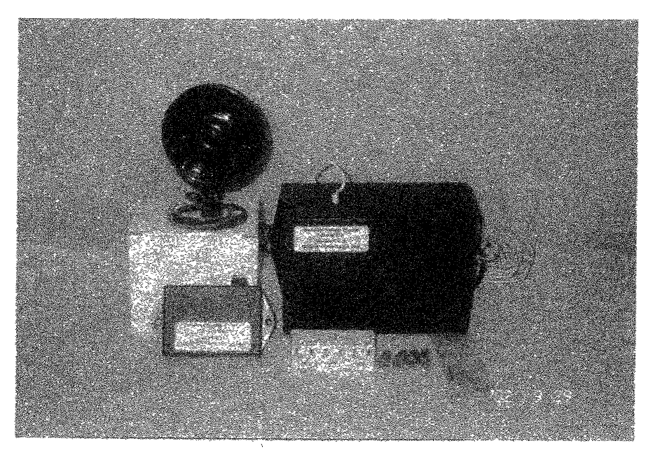

### SPECIFICATIONS

The denton sump pump alarm is now an alarm system that detects, sump pump failures, basement seepage or leakage and back up water in the center floor drain. If the water backs up into the floor drain, a sensor line will be there to detect it. if it leak or seep in from the foundaton wall, the wall floor sensor will pick it up. If the sump pump malfunctions due to clogs or the mercury ball hang ups the rising of the water will touch the snsor probe line and this will activate the siren, that will continue until turned off.

### DESCRIPTION OF SUMP PUMP ALARM

The sump pump alarm system consists of a siren for sound. A 12 vdc adapter, a test button, and for the hearing impaired a remoted box with a light emitting diode in it, a red test button on top of it for testing, and wires for making connections. The alarm system detcts sump pump failure if the sump pump motor malfunctions, water seepage or leakage, if water comes in from the foundation wall, and reverse flow water if it backs up through floor drains. If water touches any of these sensor lines, this will in turn activate the siren that goes off until turned off.

I claim;

1.) A sump pump alarm comprising;
An black plastic box that has externally a test button, a light emitting diode and a 125 vac lighted rocker switch and a 120 db 600 ma 12 vdc siren.
An adapter thats 120 vac/12 vdc, 1000 ma acceptance for maximum current load thats contained in the 5×7×3 inch plastic box.
A connecting 14 gauge 19 ft. extension cord from a 120 vac outlet;
An illuminated 125 vac, 8a rocker switch to turn power to alarm on or off,
A test button thats a normally open momentary switch.
A 12 vdc flashing led thats connected to the 12 vdc siren's output;
A 14 gauge solid wire thats put in at least two inches below the normal water line for completion of the grounding.
Three 14 gauge solid wires in which one connects to the 12 vdc adapter to at least one inch above the normal water level inside the well and the other wires are extra sensor lines.

2. A test button thats a normally open momentary switch according to claim one, Wherein said “is attatched to the 5×7×3 inch black plastic box to be pushed for testing purposes of the denton sump pump alarm”;

3. A 12 vdc flashing led thats connected to the 12 vdc siren according to claim one, wherein said, has an enclosed box; in which its screwed into the box tom be seen when it starts flashing and mounted to a wall.

4. An illuminated 125 vac 8a rocker switch according to claim one wherein said, Is screwed into outside of the 5×7×3 inch black plastic box to turn power on or off to alarm.

5. A black plastic box remoted for the hearing impaired that has a 5-6 vdc flashing led in the center of it and a red test button on top of it thats a normally open momentary switch as per claim one, used for testing the denton sump pump alarm from a distance.
